(19) United States
(12) Patent Application Publication
(10) Pub. No.: US 2019/0381760 A1
(43) Pub. Date: Dec. 19, 2019

(54) RADOME COMPRISING A LAMINATE STRUCTURE COMPRISING COMPOSITE LAYERS WHOSE FIBER REINFORCEMENT CONSISTS OF POLYOLEFIN FIBERS

(71) Applicant: DASSAULT AVIATION, Paris (FR)

(72) Inventors: Olivier CALVO PEREZ, SAINT CLOUD (FR); Benoit BERTON, SAINT CLOUD (FR)

(21) Appl. No.: 16/434,199

(22) Filed: Jun. 7, 2019

(30) Foreign Application Priority Data
Jun. 14, 2018 (FR) FR 18 00609

(51) Int. Cl. B32B 5/26

(52) U.S. Cl. CPC B32B 5/26; B32B 2605/18; B32B 2307/20; B32B 2262/0253

(57) ABSTRACT

A radome includes a laminated structure (42) in the form of a stack of composite layers (44, 46, 48, 50), each composite layer (44, 46, 48, 50) including a fibrous reinforcement mixed with an organic matrix. The composite layers includes at least one high-permittivity layer (44, 50), including a structural layer (44), and a plurality of low-permittivity layers (46, 48), including two covering layers (46, 48) sandwiching the structural layer (44) between them, each of the covering layers (46, 48) having a lower thickness to the thickness of the structural layer (44). In each low-permittivity layer (46, 48), the fibrous reinforcement includes a majority of polyolefin fibers.

The present disclosure relates to a radome, of the type comprising a laminated structure formed of a stack of composite layers, wherein each composite layer comprises a fibrous reinforcement mixed with an organic matrix, wherein the composite layers comprise:
at least one high-permittivity layer, including one structural layer, and
a plurality of low-permittivity layers, including two covering layers to form a sandwich with the structural layer between, wherein each of the covering layers has a thickness less than the thickness of the structural layer.

### BACKGROUND

Radomes consist of protective structures intended to cover antennas in order to protect them from their environment, while allowing the transmission of electromagnetic waves emitted and/or received by the antennas thus covered.

To do this, some radomes are in the form of a single layer of material. However, most often, these monolayer radomes are only transparent to electromagnetic waves over a narrow frequency band and are therefore not suitable for broadband antennas.

Multilayer radomes have been developed in order to allow the transmission of electromagnetic waves over wider frequency bands, while providing the structural rigidity necessary for the mechanical protection of antennas. These radomes consist of a stack of layers with alternating low-permittivity layers and high-permittivity layers, wherein the thicknesses and permittivities of the layers are adjusted to enhance the transparency of the radome in a frequency band and with a range of angles of incidence. There are different types of stacks, including:
type A stacks, in the form of three layers, the central layer having a low permittivity while the outer layers have high permittivities,
type B stacks, in the form of three layers, the central layer having a high permittivity, while the outer layers have low permittivities,
type C stacks, consisting of five layers, the central layer and the outer layers having high permittivities, while the intermediate layers have low permittivities, and
type D stacks, consisting of five layers, the central layer and the outer layers having low permittivities, while the intermediate layers have high permittivities.

It should be noted that “angle of incidence” or simply “incidence” is understood to mean here and in what follows, the angle between the direction of an incident electromagnetic wave striking a radome and the normal to the surface of the radome at the point struck by the wave.

Type A stacks are the most common, especially on board aircraft, because they generally have excellent mechanical strength, relative to the thickness of the stack. These stacks also allow very good transmission of electromagnetic waves in the frequency range 0-15 GHz, even in the case of high incidences.

Such a stack is known in particular from US 2014/0335752.

This type of stack, however, has significantly degraded performance in the frequency range beyond 18 GHz. In this frequency range, the ITU K band, which ranges from 17.5 to 21.2 GHz, and the Ka band, which ranges from 27.5 to 31 GHz, are found. These frequency bands are used more and more nowadays, in particular for satellite Internet, and it is now desirable to equip aircraft with antennas operating in these frequency bands.

It is also known, in particular from U.S. Pat. No. 7,420,523, to use type B stacks on board aircraft. However, there is no known stack of this type offering good electromagnetic performance in the frequency range beyond 18 GHz. In addition, stacks such as that described in U.S. Pat. No. 7,420,523 are unsatisfactory, in particular because they are difficult to industrialize and have poor wear resistance.

U.S. Pat. No. 5,408,244 discloses a radome suitable for broadband use, having an attenuation of less than 1.5 dB over a frequency range from 26 to 45 GHz and for incidences up to 30°. This radome has a stack of type D layers. While this radome is suitable for use in the Ka band, it has the disadvantage of only being suitable for use in the K band. In addition, it only allows good signal transmission at reduced angles of incidence, which makes it unsuitable for use as a communication module.

### SUMMARY OF THE INVENTION

An object of the invention is thus to provide a radome suitable for use in the K and Ka bands, even for high angles of incidence. Other objects are that the radome should have sufficient mechanical strength for use on board an aircraft, that it is light, that it has a low thickness, and that it is simple and inexpensive to produce.

For this purpose, a radome of the aforementioned type is provided, wherein the fiber reinforcement comprises a majority of polyolefin fibers in each low-permittivity layer.

According to particular embodiments of the invention, the radome also has one or more of the following characteristics, taken separately or in any technically feasible combination:
each composite layer is formed by a prepreg ply or by a superposition of prepreg plies;
the covering layers comprise the same number of prepreg plies;
the number of prepreg plies forming each of the covering layers is greater than four and is preferably between five and seven;
the number of prepreg plies forming the structural layer is greater than six and is preferably between nine and eleven;
the number of prepreg plies forming each of the covering layers is less than the number of prepreg plies forming the structural layer;
the laminated structure comprises a plurality of high-permittivity layers, including a protective layer covering one of the covering layers;
the protective layer comprises a single prepreg ply;
the protective layer has a thickness of less than 300 μm;
the protective layer has a relative permittivity of between 3.8 and 4.9, or between 3.2 and 4.0;
the high-permittivity layers consist of the structural layer and, if appropriate, the protective layer;
the radome comprises a layer of paint applied to the protective layer;
the covering layers have substantially equal permittivities, the ratio between the permittivity of the covering layers and the permittivity of the structural layer being between 0.47 and 0.60;
the structural layer has a relative permittivity less than 4.9, and preferably between 3.8 and 4.9, or between 3.2 and 4.0, while each covering layer has a relative permittivity of less than 2.6, and preferably between 2.4 and 2.6, or between 2.2 and 2.4;
the covering layers have substantially equal thicknesses, the ratio between the thickness of the covering layers and the thickness of the structural layer being between 0.5 and 0.9, or between 1.0 and 1.6;
the structural layer has a thickness of the order of λ₁/4, λ₁ being the wavelength in the structural layer, this thickness being, for example, between 2.0 and 2.4 mm, or between 1.4 and 1.8 mm;
each covering layer has a thickness of the order of λ₁/4, λ₂ being the wavelength in the covering layer, this thickness being, for example, between 1.3 and 1.7 mm, or between 1.8 and 2.2 mm;
the polyolefin fibers are predominantly composed, and preferably made, of polypropylene fibers or polyethylene fibers;
the fibrous reinforcement of the, or each, high-permittivity layer is predominantly composed, and preferably made, of mineral fibers;
the mineral fibers are mainly composed, and preferably made, of glass fibers, in particular type E glass fibers, or quartz fibers;
the low-permittivity layers consist of the covering layers;
the polyolefin fibers make up more than 50% by weight of the fibrous reinforcement; and
the fibrous reinforcement of each low-permittivity layer consists of polyolefin fibers.

An aircraft is also provided comprising a radome as defined above.

### BRIEF SUMMARY OF THE DRAWINGS

Other features and advantages of the invention will become apparent upon reading the description which follows, given solely by way of example and with reference to the appended drawings, wherein:

FIG. 1 shows a side view, in elevation, of an aircraft according to an embodiment of the invention,

FIG. 2 shows a partial sectional view of a communication module of the aircraft of FIG. 1;

FIG. 3 shows a view of a detail marked III in FIG. 2,

FIG. 4 shows a perspective view of a prepreg ply used in the composition of the communication module of FIG. 2, and

FIG. 5 shows a view of a marked detail V of FIG. 2.

### DETAILED DESCRIPTION

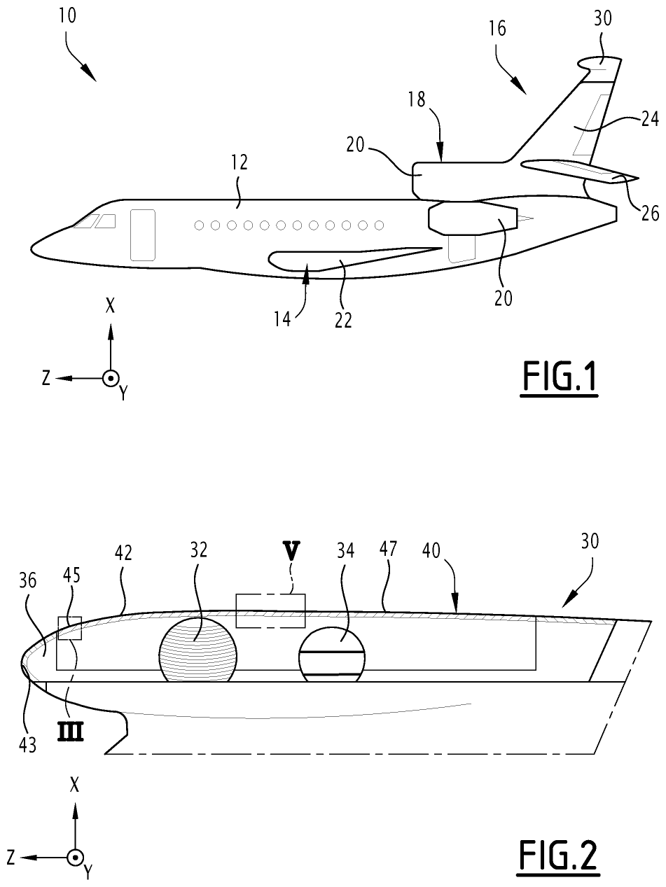

The aircraft 10 shown in FIG. 1 is in the form of an airplane. It comprises, in a known manner, a fuselage 12, a wing 14, a tail 16 and a power train 18, the latter here being in the form of three turbojet engines 20, only two of which are visible in FIG. 1.

In the following, the terms of reference are understood with reference to the usual orthogonal reference frame of the aircraft, which is represented in the figures, wherein may be seen:
a longitudinal direction X oriented from the rear to the front,
a transverse direction Y oriented from right to left, the transverse direction Y forming with the longitudinal direction X a horizontal plane (X, Y), and
a vertical direction Z oriented from bottom to top, the vertical direction Z forming:
   with the longitudinal direction X a longitudinal plane (X, Z), and
   with the transverse direction Y a transverse plane (Y, Z).

The fuselage 12 is elongated in the longitudinal direction X. It is, in particular, tubular and is centered on a longitudinal axis forming the axis of the fuselage 12.

The lift surfaces 14 are in the form of a pair of wings 22 (only the left wing being visible in FIG. 1) arranged symmetrically on either side of the fuselage 12 in the transverse direction Y.

The tail 16 is disposed at the rear of the fuselage 12. It comprises a vertical fin 24 and, disposed symmetrically on either side of the fin 24 in the transverse direction Y, two substantially horizontal stabilizers 26 (only the left stabilizer is visible in FIG. 1).

The aircraft 10 further comprises a radome 30 protecting the antennas 32, 34 (FIG. 2). This radome 30 is in the form of a communication module disposed at the top of the fin 24.

Each antenna 32, 34 is illustrated here by a disk representing its volumetric sphere.

The antennas 32, 34 here comprise a first antenna 32 receiving in the band K, and transmitting in the band Ka. The first antenna 32 is typically a transceiver antenna for high-speed satellite Internet.

The first antenna 32 does not comprise its own radome. The radome 30 is therefore the only protection of the first antenna 32 against the environment.

With reference to FIG. 2, the radome 30 defines a closed cavity 36 in which the antennas 32, 34 are housed, and comprises a laminated structure 40 covering this cavity 36.

The laminated structure 40 comprises a central portion 42 transparent to the electromagnetic waves emitted and received by the antennas 32, 34, and a peripheral portion 43 that is opaque to the electromagnetic waves. It should be noted that the terms “transparent” and “opaque” are relative, wherein the so-called “transparent” portion 42 does not necessarily permit the perfect transmission of the electromagnetic waves emitted and received by the antennas 32, 34 (as is described in more detail later), while the portion 43 described as “opaque” does not necessarily form a perfect barrier to these electromagnetic waves.

The transparent portion 42 here has the general shape of a cylindrical trunk. Advantageously, the transparent portion 42 is curved to increase the reception volume of the antennas 32, 34 and to improve the aerodynamics of the radome 30.

The transparent portion 42 comprises a peripheral region 45, which forms the interface between the transparent portion 42 and the opaque portion 43, and a central region 47.

With reference to FIG. 3, the transparent portion 42 is in the form of a stack of composite layers 44, 46, 48, 50, each composite layer 44, 46, 48, 50 comprising a fibrous reinforcement mixed with an organic matrix.

The layers 44, 46, 48, 50 are stacked in a stacking direction that is locally orthogonal to a plane locally tangential to an outer surface of the central portion 42. For each layer 44, 46, 48, 50, a thickness of the layer 44, 46, 48, 50 is constituted by the dimension of the layer 44, 46, 48, 50 in the stacking direction.

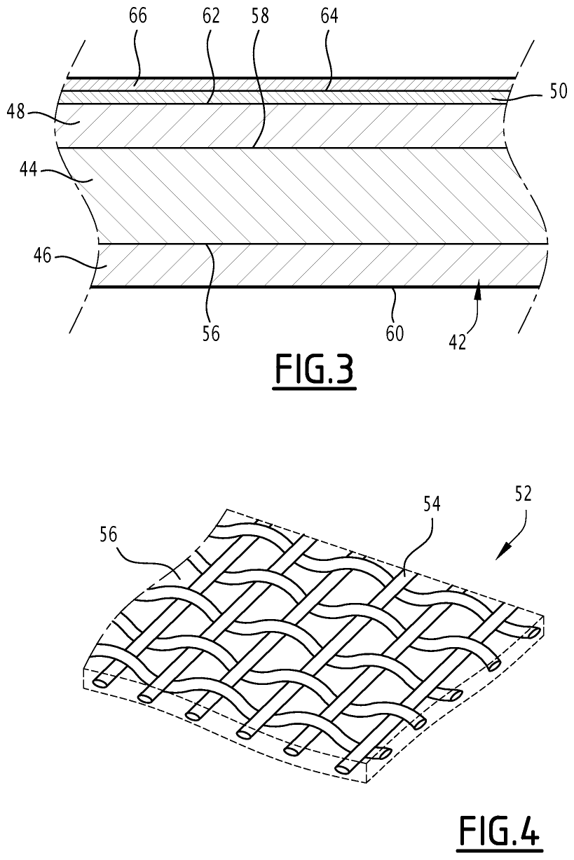

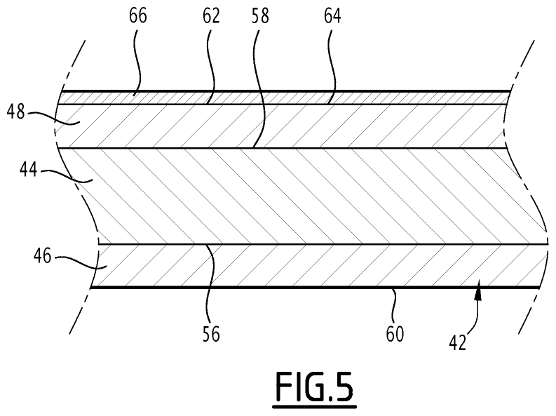

Each composite layer 44, 46, 48, 50 is, in particular, formed by a prepreg ply or by a superposition of prepreg plies superimposed on each other in the direction of the stack, such as the prepreg ply 52 shown in FIG. 4.

With reference to FIG. 4, each prepreg ply used in the composition of one of the composite layers 44, 46, 48, 50 comprises, as well as the prepreg ply 52, a fiber reinforcement 54 embedded in an organic matrix 56. When the composite layer 44, 46, 48, 50 consists of a single ply, the fibrous reinforcement 54 constitutes the fibrous reinforcement of the layer 44, 46, 48, 50, while the organic matrix 56 constitutes the matrix of the layer 44, 46, 48, 50. When the composite layer 44, 46, 48, 50 is in the form of a superimposed plies, the fibrous reinforcement of the layer 44, 46, 48, 50 consists of the joining of the fibrous reinforcements 54 of the different plies constituting the layer 44, 46, 48, 50, while the organic matrix of the layer 44, 46, 48, 50 consists of the joining of organic matrices of different plies constituting the layer 44, 46, 48, 50.

Preferably, the fiber reinforcement 54 of each prepreg ply used in the composition of one of the composite layers 44, 46, 48, 50 is constituted by a woven reinforcement.

The prepreg plies constituting the same layer 44, 46, 48, 50 are all substantially identical to each other in terms of the composition of the fibrous reinforcement 54 of the composition of the organic matrix 56, and of the mass ratio between the fibrous reinforcement 54 and the organic matrix 56.

Returning to FIG. 3, the composite layers 44, 46, 48, 50 comprise high-permittivity layers 44, 50 and low-permittivity layers 46, 48.

Each high-permittivity layer 44, 50 has a permittivity greater than the permittivity of each low-permittivity layer 46, 48.

Each high-permittivity layer 44, 50, however, has a relative permittivity of less than 4.9 in the K and Ka frequency bands. In a first embodiment of the invention, this relative permittivity in the K and Ka frequency bands is between 3.8 and 4.9. In a second embodiment of the invention, this relative permittivity in the K and Ka frequency bands is between 3.2 and 4.0.

For this purpose, the fibrous reinforcement of each high-permittivity layer 44, 50 is predominantly composed, and preferably made, of mineral fibers. In the first embodiment, these mineral fibers are predominantly composed, and preferably made, of glass fibers, in particular type E glass fibers. In the second embodiment, these mineral fibers are predominantly composed, and preferably made of, quartz fibers. The organic matrix is preferably constituted by a thermosetting resin, for example an epoxy resin. In addition, the weight ratio between the fibrous reinforcement and the organic matrix is advantageously between 1.5 and 2, the fibrous reinforcement mass being greater than the mass of organic resin.

“The fiber reinforcement is mainly composed of” fibers of a particular type is understood to mean here and in what follows that the fibers of the particular type make up more than 50% by weight of the fibrous reinforcement.

These characteristics are also shared by each prepreg ply constituting one of the high-permittivity layers 44, 50.

Advantageously, the fiber reinforcement 54 of each prepreg ply constituting one of the high-permittivity layers 44, 50, is constituted by an 8×8 satin.

Each low-permittivity layer 46, 48 has a relative permittivity of less than 2.6 in the K and Ka frequency bands. In the first embodiment, this relative permittivity is between 2.4 and 2.6 in the K and Ka frequency bands. In the second embodiment, this relative permittivity is between 2.2 and 2.4 in the K and Ka frequency bands.

For this purpose, the fibrous reinforcement of each low-permittivity layer 46, 48 is predominantly composed, and preferably made, of polyolefin fibers, these polyolefin fibers being advantageously predominantly composed, and preferably made, of polypropylene fibers or, alternatively, of polyethylene fibers. The organic matrix is preferably constituted by a thermosetting resin, for example an epoxy resin. In addition, the weight ratio between the fibrous reinforcement and the organic matrix is advantageously between 1 and 0.75, the fibrous reinforcing mass being lower than the mass of organic resin.

These characteristics are also shared by each prepreg ply constituting one of the low-permittivity layers 46, 48.

For example, the fibrous reinforcement 54 of each prepreg ply constituting one of the low-permittivity layers 46, 48 is constituted by a taffeta.

The high permittivity layers 44, 50 are constituted by a structural layer 44, forming the core of the fibrous structure 40, and a protective layer 50. The low-permittivity layers 46, 48 are constituted by two covering layers of cover sandwiching the structural layer 44 between them. “Sandwiching” it is understood to mean here and in what follows, that the covering layers 46, 48 are arranged on either side of the structural layer 44 in the direction of stacking, each covering layer 46, 48 being contiguous to the structural layer 44; in other words, the covering layers 46, 48 frame the structural layer 44 in the stacking direction, each covering layer 46, 48 being in contact with the structural layer 44.

The covering layers 46, 48 thus form, with the structural layer 44, a type B stack.

The structural layer 44 has a thickness of the order of λ₁/4, where λ₁ is the average wavelength in the layer 44, of the waves included in the K and Ka bands. Thus, in the first embodiment, the structural layer 44 has a thickness of between 2.0 and 2.4 mm, while, in the second embodiment, the structural layer 44 has a thickness of between 1.4 and 1.8 mm.

For this purpose, the structural layer 44 is in the form of a plurality of prepreg plies, the number of the plies being greater than six and preferably being between nine and eleven and, for example, equal to ten.

The covering layers 46, 48 comprise an inner layer 46, disposed inside the cavity 36 relative to the structural layer 44, and an outer layer 48, disposed outside the cavity 36 relative to the outer structural layer 44. In other words, the inner layer 46 is contiguous to an inner face 56 of the structural layer 44 facing the cavity 36, while the outer layer 48 is contiguous to an outer face 58 of the structural layer 44 oriented opposite the cavity 36.

The inner layer 46 defines an inner face 60 facing the cavity 36, of the central portion 42. In this case, this inner face 60 is open, i.e. it is not covered by another element.

The outer layer 48 has an outer face 62, facing away from the cavity 36. As may be seen in FIG. 5, this outer face 62 defines, in the central region 47, an outer face 64, oriented opposite the cavity 36 of the transparent portion 42. In the peripheral region 45, however, this outer face 62 is covered by the protective layer 50, as may be seen in FIG. 3.

The covering layers 46, 48 have substantially equal permittivities, the ratio between the permittivity of the covering layers 46, 48 and the permittivity of the structural layer 44 being between 0.47 and 0.60.

In addition, the covering layers 46, 48 have thicknesses substantially equal to one another and less than the thickness of the structural layer 44. In the first embodiment, these thicknesses of the covering layers 46, 48 are, in particular, such that the ratio between their thicknesses and the thickness of the structural layer 44 is between 0.5 and 0.9. In the second embodiment, these thicknesses of the covering layers 46, 48 are, in particular, such that the ratio between their thicknesses and the thickness of the structural layer 44 is between 1.0 and 1.6.

For example, each covering layer 46, 48 has a thickness of the order of λ₂/4, where λ₂ is the average wavelength in the covering layer 46, 48, of the waves included in the K and Ka bands. Thus, in the first embodiment, each covering layer 46, 48 has a thickness of between 1.3 and 1.7 mm, while in the second embodiment, each covering layer 46, 48 has a thickness between 1.8 and 2.2 mm.

For this purpose, the covering layers 46, 48 comprise the same number of prepreg plies, this number being greater than four and less than the number of prepreg plies forming the structural layer 44. For example, the number of plies forming each covering layers 46, 48 is between five and seven, and is preferably six.

The protective layer 50 extends exclusively in the peripheral region 45 of the transparent portion 42. It defines therein the outer face 64 of the transparent portion 42.

The protective layer 50 has a low thickness relative to the thickness of the thinnest layer 44, 46, 48. “Low” is understood to mean that the ratio of the thickness of the protective layer 50 to that of the thinner layers 44, 46, 48, is less than 20%. In particular, this thickness is less than 300 μm.

Thus, the protective layer 50 has little influence on the transmission of electromagnetic waves through the peripheral region 45.

For this purpose, the protective layer 50 consists of a single prepreg ply.

Thus, in the first embodiment, the total thickness of the transparent portion 42 is between 4.6 and 5.8 mm in the central region 47, and between 4.8 and 6.1 mm in the peripheral region 45. In the second embodiment, this total thickness of the transparent portion 42 is between 5.0 and 6.2 mm in the central region 47, and between 5.2 and 6.4 mm in the peripheral region 45.

The opaque portion 43 is itself monolayer, consisting of a single composite layer with high permittivity. This opaque portion 43 is, in particular, formed by a superposition of prepreg plies that, in number are equal to the total number of plies forming the high-permittivity layers 44, 50 of the transparent portion 42, these prepreg plies being identical to the prepreg plies composing the high-permittivity layers 44, 50 of the transparent portion 42.

The total thickness of the opaque portion 43 is preferably substantially equal to the sum of the thicknesses of the high-permittivity layers 44, 50.

Still with reference to FIG. 3, the radome 30 further comprises a layer 66 of paint applied to the outer face of the laminated structure 40, wherein the outer face includes the outer face 64 of the transparent portion 42.

This layer of paint 66 extends over the entire peripheral region 45 and the central region 47.

The layer of paint 66 has a low thickness relative to the thickness of the thinnest layer 44, 46, 48. “Low” is understood to mean that the ratio of the thickness of the layer of paint 66 to that of the thinner layers 44, 46, 48 is less than 10%. In particular, this thickness is less than 150 μm.

Depending on the permittivity characteristics of the layer of paint 66, the permittivity and thickness values of the layers 44, 46 and 48 are adjusted within the previously mentioned ranges.

It has been observed that the transparent portion 42 of the radome 30 offers, thanks to the characteristics described above, particularly good performance in terms of transmission of electromagnetic waves in the K and Ka bands. In fact, it has been observed that for frequencies between 18 and 31 GHz and for angles of incidence up to 50°, the attenuation of the electromagnetic waves through the central painted portion 42 does not exceed a value of the order of 1 dB.

It has also been observed, surprisingly, that this transparency of the central portion 42 is not obtained to the detriment of the mechanical characteristics of the latter, since the central portion 42 is adapted to take the mechanical loads that it would be likely to encounter in the flight envelope of the aircraft 10.

Thanks to the radome 30 described above, the antennas 32, 34 are efficiently protected from their environment, while continuing to be able to transmit and receive signals without excessive attenuation thereof.

In addition, the radome 30 has little impact on the mass and the cost of the aircraft 10, because of the low density of the materials used, the low thickness of the structure 40, and the inexpensive production method of the structure 40, which may, in fact, be manufactured by means of a standard method of manufacturing composite laminated pieces, by successive laying of prepreg plies in order to achieve a preform, before consolidation of the preform to form the structure 40.

Moreover, thanks to the reduced number of layers, it is possible to vary the thickness of these layers within relatively large margins of tolerance without significantly impacting the electromagnetic performance of the radome 30. The radome 30 may thus be easily produced industrially.

It will be appreciated that while the laminate structure 40 has herein been described as including a protective layer 50 extending partly into the transparent portion 42, this protective layer 50 is optional. Thus, alternatively, the stack of composite layers forming the transparent portion 42 need not include a protective layer 50; wherein this stack then comprises a single high-permittivity layer, constituted by the structural layer 44, while the transparent portion 42 has a homogeneous total thickness between its central region 47 and its peripheral region 45, constituted by the thickness given above for the central region 47.

On the contrary, it should be noted that the protective layer 50 need not be limited only to the peripheral region 45 of the transparent portion 42, but may extend over the entirety of the transparent portion 42, including in the central region 47. Thus, according to another variant not shown of the invention, the protective layer 50 covers the outer face 62 of the outer layer 48 including the central region 47, while the outer face 62 never defines the outer face 64 of the transparent portion 42. The transparent portion 42 then has a total homogeneous thickness between its central region 47 and its peripheral region 45, constituted by the thickness given above for the peripheral region 45.

What is claimed is:

1. A radome comprising a laminate structure in the form of a stack of composite layers, each of the composite layers comprising a fibrous reinforcement mixed with an organic matrix, the composite layers comprising:
at least one high-permittivity layer, including a structural layer; and
a plurality of low-permittivity layers, including two covering layers sandwiching the structural layer between the two covering layers,
wherein in each of the low-permittivity layers, the fibrous reinforcement comprises a majority of polyolefin fibers.

2. The radome according to claim 1, wherein each of the composite layers is formed by a prepreg ply or by a superposition of prepreg plies.

3. The radome according to claim 2, wherein the covering layers comprise a same number of prepreg plies.

4. The radome according to claim 2, wherein a number of the prepreg plies forming each of the covering layers is greater than four.

5. The radome according to claim 2, wherein a number of the prepreg plies forming the structural layer is greater than six.

6. The radome according to claim 1, wherein the at least one high-permittivity layer comprises a plurality of the high-permittivity layers, including a protective layer covering one of the covering layers.

7. The radome according to claim 6, wherein each of the composite layers is formed by a prepreg ply or by a superposition of prepreg plies and wherein the protective layer comprises a single prepreg ply.

8. The radome according to claim 6, wherein the protective layer has a thickness of less than 300 μm.

9. The radome according to claim 1, wherein the covering layers have substantially equal permittivities, a ratio between the permittivity of the covering layers and the permittivity the structural layer being between 0.47 and 0.60.

10. The radome according to claim 1, wherein the structural layer has a relative permittivity of less than 4.9, while each of the covering layers has a lower relative permittivity of 2.6.

11. The radome according to claim 10, wherein the structural layer has a relative permittivity of between 3.8 and 4.9, or between 3.2 and 4.0.

12. The radome according to claim 10, wherein each of the covering layers has a relative permittivity of between 2.4 and 2.6, or between 2.2 and 2.4.

13. The radome according to claim 1, wherein each of the covering layers has a thickness less than a thickness of the structural layer.

14. The radome according to claim 1, wherein the covering layers have substantially equal thicknesses, a ratio between a thickness of the covering layers and a thickness of the structural layer being between 0.5 and 0.9, or between 1.0 and 1.6.

15. The radome according to claim 1, wherein the structural layer has a thickness of an order of λ₁/4, λ₁ being the wavelength in the structural layer.

16. The radome according to claim 15, wherein the thickness of the structural layer is between 2.0 and 2.4 mm, or between 1.4 and 1.8 mm.

17. The radome according to claim 1, wherein each of the covering layers has a thickness of the order of λ₁/4, λ₂ being the wavelength in the covering layer.

18. The radome according to claim 1, wherein the polyolefin fibers are mainly composed of polypropylene fibers or polyethylene fibers.

19. The radome according to claim 18, wherein the polyolefin fibers consist of polypropylene fibers or polyethylene fibers.

20. Aircraft comprising the radome according to claim 1.
